(19) United States
(12) Patent Application Publication
(10) Pub. No.: US 2018/0247046 A1
(43) Pub. Date: Aug. 30, 2018

(54) ELECTRONIC DEVICE, INFORMATION PROCESSING SYSTEM, INFORMATION MANAGING APPARATUS, INFORMATION PROCESSING METHOD, AND INFORMATION PROCESSING PROGRAM

(71) Applicant: Manami KIKUCHI, Kanagawa (JP)

(72) Inventor: Manami KIKUCHI, Kanagawa (JP)

(73) Assignee: Ricoh Company, Ltd., Tokyo (JP)

(21) Appl. No.: 15/964,358

(22) Filed: Apr. 27, 2018

Related U.S. Application Data
(63) Continuation of application No. 14/360,346, filed on May 23, 2014.

(30) Foreign Application Priority Data
Jan. 18, 2012 (JP) 2012-007778
Oct. 26, 2012 (JP) 2012-236411

(51) Int. Cl. G06F 21/44; G06F 21/31; G06F 3/12; H04N 1/44

(52) U.S. Cl. CPC G06F 21/44; G06F 21/31; G06F 3/1225; G06F 3/1203; H04N 1/4433; H04N 1/32106; H04N 2201/3208; H04N 2201/3205; H04N 2201/3278; H04N 2201/0094; H04N 1/4413

(57) ABSTRACT

An electronic device includes: a reception section to receive attribute information of input items inherent to an installed program as the input items for authentication; a storing section to store the attribute information; a display controlling section to display an input screen on a display section for entering the input items inherent to the program in addition to common input items for multiple programs based on the attribute information stored in the storing section, in response to an execution command from the program; and an indicating section to indicate input values for the input items inherent to the program to the program with respect to the inherent input items.

### CROSS-REFERENCE TO RELATED APPLICATIONS

The present application is a continuation application filed under 35 U.S.C. 111(a) claiming the benefit under 35 U.S.C. 120 of U.S. patent application Ser. No. 14/360,346 filed on May 23, 2014, which is the National Stage of International Application No. PCT/JP2012/084253, filed on Dec. 21, 2012, which is based on and claims the benefit of priority to Japanese Priority Application No. 2012-007778, filed on Jan. 18, 2012, and Japanese Priority Application No. 2012-236411, filed on Oct. 26, 2012, the entire contents of which are hereby incorporated herein by reference.

### TECHNICAL FIELD

The disclosures herein generally relate to electronic devices, information processing systems, information management apparatuses, information processing methods, and information processing programs.

### BACKGROUND ART

In recent years, electronic devices such as image forming apparatuses including Multifunction Peripherals (MFPs) or Line Printers (LPs) have an open interface for software programming, which makes it possible for third-party vendors or developers other than manufacturers of the electronic devices to develop application programs to be installed to enhance functions of the electronic devices. Such enhancement of functions enables, for example, collaborations between users' business systems and the electronic devices, which may result in higher integration between the electronic devices and the users' business.

The above electronic devices authenticate users of application programs in a common or uniform way for multiple applications.

However, there are needs for authentication with which inherent input items can be entered for each individual application program. For example, whereas a user ID and a password are specified as common input items, some application programs may need to have input items other than the user ID and password.

### REFERENCE

Japanese Laid-open Patent Publication No. 2007-49677

### SUMMARY OF THE INVENTION

It is an object of the present invention, in the light of these circumstances, to provide electronic devices, information processing systems, information management apparatuses, information processing methods, and information processing programs with which input items inherent to an application program can be entered when entering input items for authentication.

To obviate the above problems, an electronic device includes:

a reception section to receive, from an installed program, attribute information of input items inherent to the installed program as input items for authentication;

a storing section to store the attribute information;

a display controlling section to display an input screen on a display section for entering the input items inherent to the program in addition to common input items for multiple programs based on the attribute information stored in the storing section, in response to an execution command to execute the program; and

an indicating section to indicate input values for the input items inherent to the program to the program with respect to the inherent input items.

It allows entering inherent input items for an application program used as inputs for authentication.

### BRIEF DESCRIPTION OF THE DRAWINGS

FIG. 1 is a figure illustrating an example of a hardware configuration in an embodiment of the invention.

FIG. 2 is a figure illustrating an example of a software configuration in an embodiment of the invention.

FIG. 3 is a flowchart illustrating an example of processing steps executed when an SDK application is activated.

FIG. 4 is a figure illustrating an example of a configuration of authentication setup information.

FIG. 5 is a flowchart illustrating an example of processing steps executed when an SDK application is executed.

FIG. 6 is a figure illustrating an example of input screens displayed for entering common input items.

FIG. 7 is a figure illustrating an example of an input screen displayed for entering inherent input items.

FIG. 8 is a sequence chart illustrating an example of operations of software programs executed when an SDK application is activated.

FIG. 9 is a sequence chart illustrating an example of operations of software programs executed when an SDK application is executed.

FIG. 10 is a figure illustrating an example of a system configuration where authentication setup information is stored outside of an image forming apparatus.

### BEST MODE OF CARRYING OUT THE INVENTION

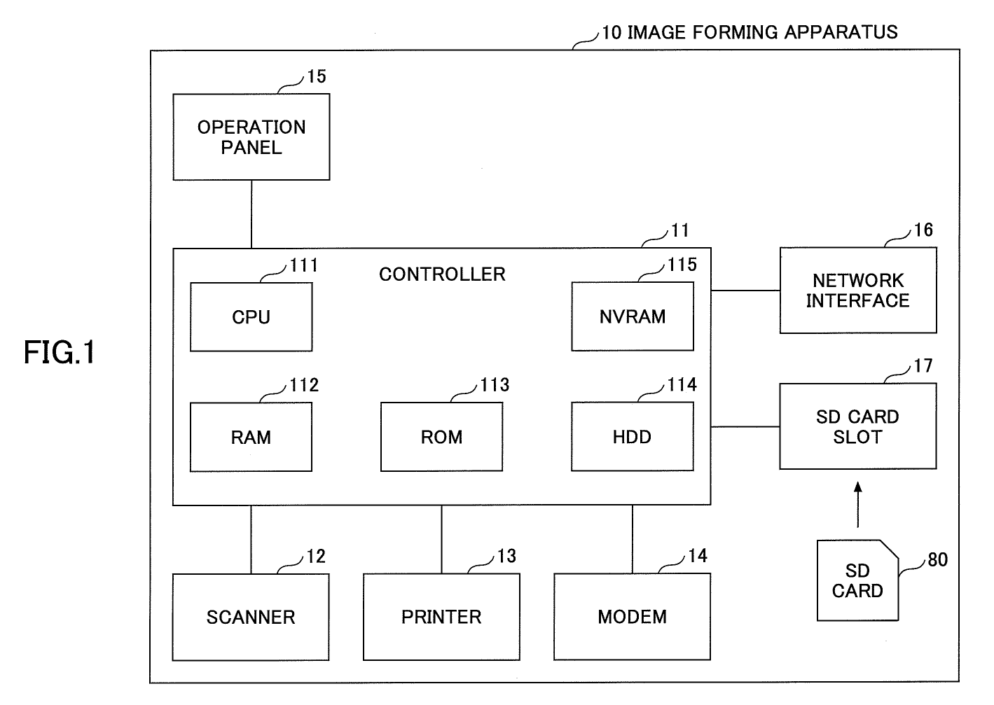

Embodiments of the invention will be explained in conjunction with the accompanying drawings as follows. FIG. 1 is a figure illustrating an example of a hardware configuration in an embodiment of the invention. In FIG. 1, an image forming apparatus 10 as an example of an electronic device includes hardware such as a controller 11, a scanner 12, a printer 13, a modem 14, an operation panel 15, a network interface 16, an SD card slot 17, and the like.
The controller 11 includes a CPU 111, a RAM 112, a ROM 113, an HDD 114, and an NVRAM 115 and the like. The ROM 113 stores various programs, data used by the programs, and the like. The RAM 112 is used as a memory area to load programs or a work area for the loaded programs. The CPU 111 performs various functions by processing the programs loaded to the RAM 112. The HDD 114 stores programs, various data used by the programs, and the like. The NVRAM 115 stores various pieces of setup information.

The scanner 12 is hardware for capturing image data from an original copy (an image capturing means). The printer 13 is hardware for printing print data on printing paper (a printing means). The modem 14 is hardware for connecting to a telephone line, and is used for sending/receiving image data by FAX communication. The operation panel 15 is hardware having an input means such as buttons for receiving inputs from a user, and a display means such as an LCD panel. The LCD panel may have a touch panel function. In this case, the LCD panel is also used as an input means. The network interface 16 is hardware for connecting to a network such as a LAN, or any other wired or wireless network. The SD card slot 17 is used for reading programs stored on the SD card 80, i.e., the image forming apparatus 10 executes not only programs stored in the ROM 113, but also programs stored in the SD card 80 by loading the programs in the RAM 112. It is noted that other recording media, for example, a CD-ROM or a USB (Universal Serial Bus) memory, may be used instead of the SD card 80, i.e., types of recording media exemplified with the SD card 80 are not restricted to predetermined types. In this case, the SD card slot 17 may be replaced with appropriate hardware according to the used recording media. It is noted that a program which controls the image forming apparatus 10 may be a Web application program or the like installed on a remote computer connected via a network.

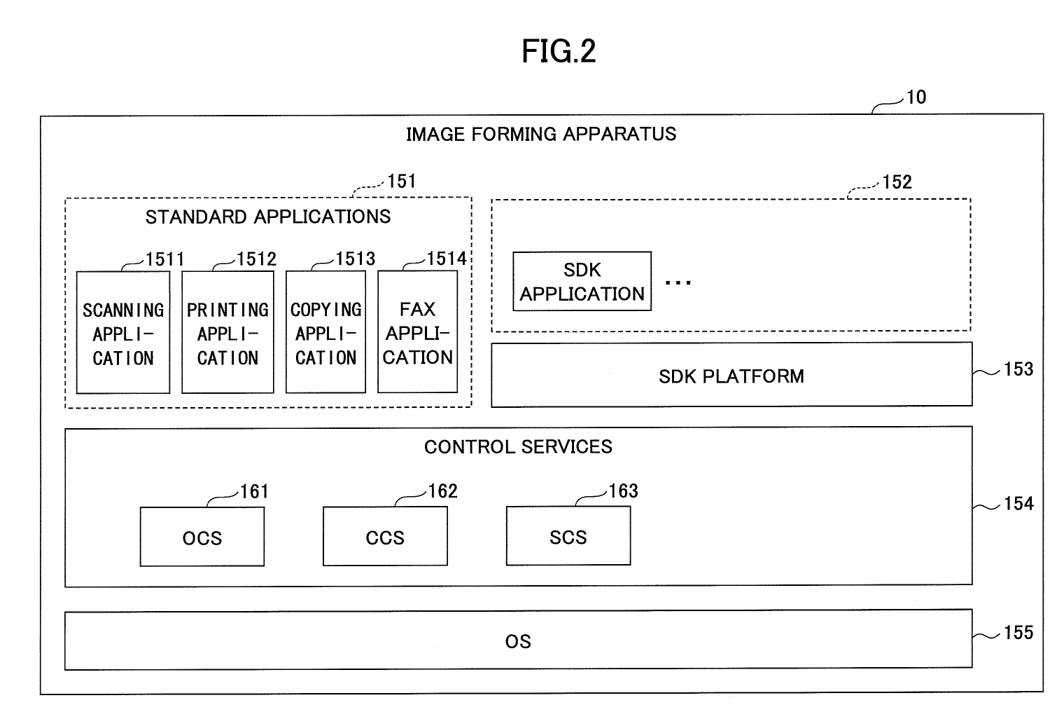

FIG. 2 is a figure illustrating an example of a software configuration in the present embodiment of the invention. In FIG. 2, the image forming apparatus 10 includes standard applications 151, an SDK application 152, an SDK platform 153, control services 154, an OS 155 and the like.

The standard applications 151 are a standard set of application programs in the image forming apparatus 10 preinstalled at the time of shipment. In FIG. 2, a scanning application 1511, a printing application 1512, a copying application 1513, and a FAX application 1514 are shown as examples. The scanning application 1511 executes scanning jobs. The printing application 1512 executes printing jobs. The copying application 1513 executes copying jobs. The FAX application 1514 executes FAX sending/receiving jobs.

Control services 154 are a group of software modules which provide various functions such as controlling hardware resources for upper applications, or execute basic functions of the image forming apparatus 10. In FIG. 2, as elements configuring the control services 154, an OCS (operation panel control service) 161, a CCS (certification control service) 162, an SCS (system control service) 163 and the like are shown as examples. The OCS 161 executes display control for the operation panel 15. The CCS 162 controls processing for authentication processing or accounting processing. The SCS 163 controls processing for management of the overall system of the image forming apparatus 10.

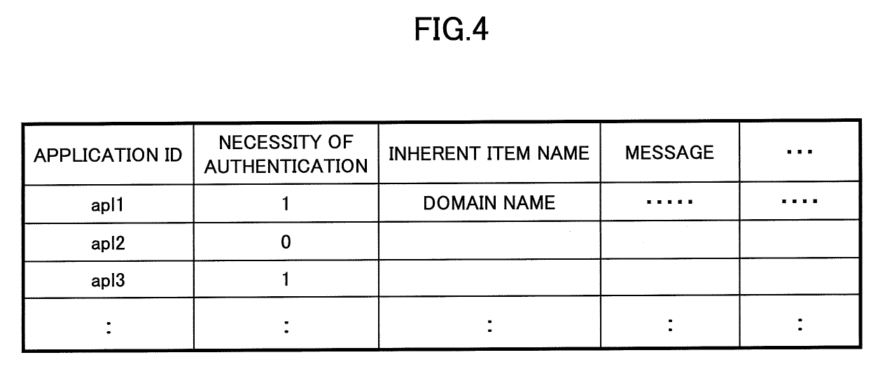

A particular SDK application 152 shown in FIG. 4 is an example of application programs installed additionally after shipment of the image forming apparatus 10 as a plugin to extend functions of the image forming apparatus 10. The function of each of the SDK applications 152 is not restricted to predetermined ones.

The SDK platform 153 provides an execution environment for the SDK applications 152. Each of the SDK applications 152 is developed with an API (Application Program Interface) provided by the SDK platform 153. For example, the SDK platform 153 provides an interface for using a scanning function, an interface for using a printing function, an interface for using a copying function, and the like. It is noted that the API of the SDK platform 153 API is disclosed. Therefore third-party vendors or the like may develop SDK applications 152. Also, the SDK platform 153 includes a Java (a registered trademark) virtual machine. Each of the SDK applications 152 is activated as a thread on the Java (a registered trademark) virtual machine.

The OS 155 is an available OS (Operating System). Each piece of software runs as a process or a thread on the OS 155.

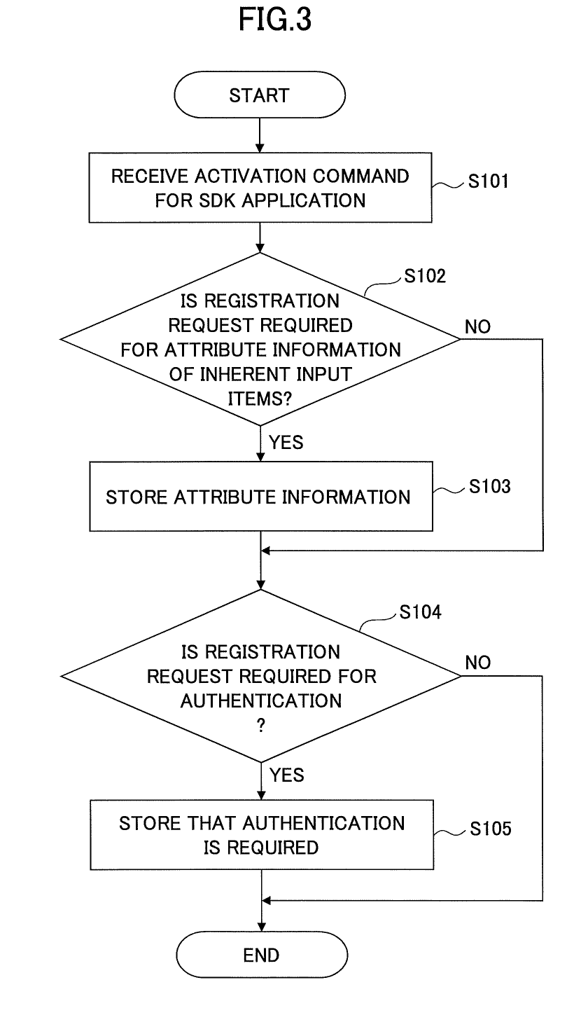

Processing steps executed by the image forming apparatus 10 will be explained as below. FIG. 3 is a flowchart illustrating an example of processing steps executed when an SDK application is activated. An activation of an SDK application 152 means the SDK application 152 is activated as a thread. A user may select an SDK application 152 to be activated from the installed SDK applications 152, i.e., an activation of the SDK application 152 does not mean the SDK application 152 is executed immediately. In the present embodiment, an execution of an SDK application 152 means the SDK application 152 makes the image forming apparatus 10 execute processing related to functions implemented with the SDK application 152. From a user's point of view, the execution of the SDK application 152 means to use the functions of the SDK application 152.

It is noted that in FIG. 3, the timing of an activation of the SDK application 152 may be restricted to the first activation of the SDK application 152 after its installation, or may be at every activation.

When the image forming apparatus 10 receives an activation command of an SDK application 152 specified by a user, the image forming apparatus 10 activates the SDK application 152, called the “target application to be activated” hereafter, as a thread at Step S101. The activation command of the SDK application 152 may be received, for example, by selecting a target SDK application to be activated from a list of SDK applications 152 installed in the image forming apparatus 10, shown on a screen for selection.

Next, after the image forming apparatus 10 receives a registration request of attribute information of inherent, or unique, input items for the target application to be activated (“YES” at Step S102), the image forming apparatus 10 stores the attribute information in the NVRAM 115 or the HDD 114.

It is noted that the inherent input items mean input items for which the target application to be activated needs inputs from a user besides common input items for multiple SDK applications 152, on an authentication screen, or a login screen, displayed when the target application to be activated is to be executed. Also, the attribute information of the inherent input items includes, for example, the name of an item, a message, etc. A message is a string displayed when prompting a user to input values for the inherent input items.

When the target application to be activated does not require a registration request of the attribute information of the inherent input items (“NO” at Step S102), Step S103 will not be executed.

Next, after the image forming apparatus 10 receives a registration request that authentication is required at an execution of the application (“YES” at Step S104), the image forming apparatus 10 stores the information in the NVRAM 115 or the HDD 114, to indicate that authentication is required at an execution of the target application to be activated. On the other hand, when the target application to be activated does not require a registration for authentication (“NO” at Step S104), Step S105 will not be executed. Namely, it is possible for the image forming apparatus 10 to set the necessity of authentication for each of the SDK applications 152.

When FIG. 3 is executed at an activation of each of the SDK applications 152, setup information, called “authentication setup information” hereafter, for example, as shown in FIG. 4, is stored in the NVRAM 115 or the HDD 114.

FIG. 4 is a figure illustrating an example of a configuration of the authentication setup information. In FIG. 4, the authentication setup information includes an application ID, the necessity of authentication, the name of an inherent item, and a message for each of the SDK applications 152.

An application ID is identification information to identify each of the SDK applications 152. The necessity of authentication is information to indicate whether authentication is required at an execution of the SDK application 152, stored at Step S105. As for the necessity of authentication, “1” indicates that authentication is required, “0” indicates that authentication is not required.

The name of an inherent item and the message are the item name of inherent input items of an SDK application 152, and the message for the input items, stored at Step S103.

It is noted that in FIG. 4, an SDK application 152 with the application ID “ap11” requires authentication. It is an example of an SDK application 152 which requires inherent input items at authentication. An SDK application 152 with the application ID “ap12” is an example of an SDK application 152 which does not require authentication. An SDK application 152 with the application ID “ap13” is an example of an SDK application 152 which requires authentication, but does not require inherent input items.

It is noted that when the processing in FIG. 3 is executed at every activation of an SDK application 152, the authentication setup information may be stored in the RAM 112.

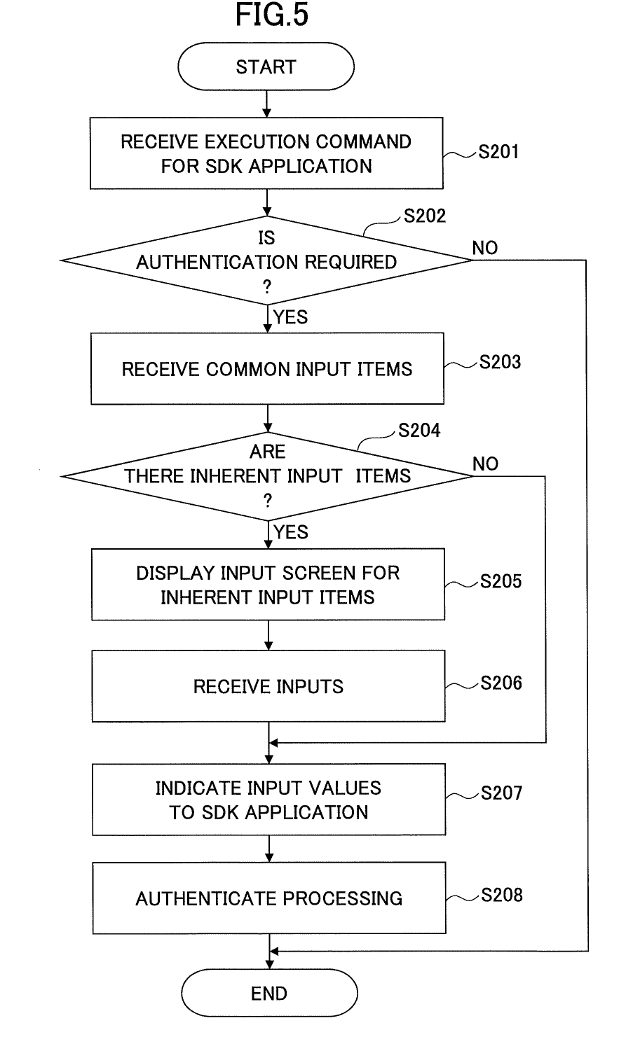

Next, processing steps executed during an execution of an SDK application 152 will be explained. FIG. 5 is a flowchart illustrating an example of processing steps executed when an SDK application is executed.

At Step S201, the image forming apparatus 10 receives an execution command or use command of an SDK application 152 in the activated SDK applications 152 from a user. Next, the image forming apparatus 10 determines the necessity of authentication of the SDK application 152, called the “target application to be executed” hereafter. The necessity of authentication can be determined by referring to the value of the “NECESSITY OF AUTHENTICATION” field in the authentication setup information (FIG. 4) corresponding to the application ID of the target application to be executed. Namely, if the value is “1”, it is determined that authentication is required. if the value is “0”, it is determined that authentication is not required.

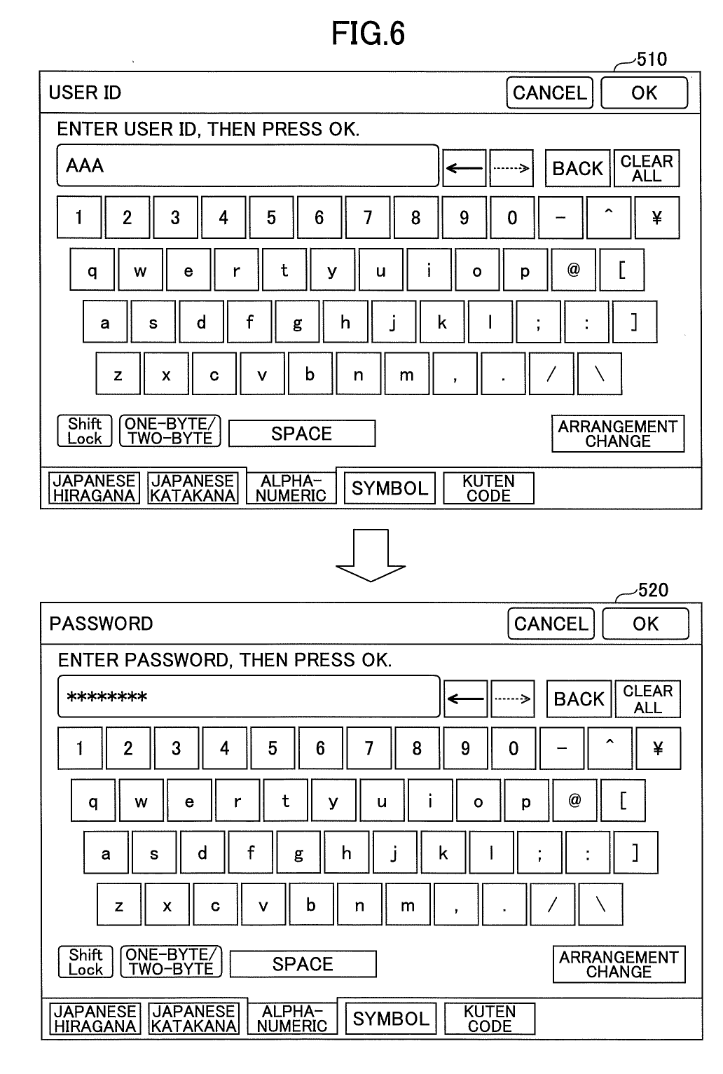

If authentication is required (“YES” at Step S202), the image forming apparatus 10 receives inputs of values for the common or default input items related to authentication at Step S203. In the present embodiment, a user ID and a password are assumed as common input items, although other input items may be treated as common input items. In Step S203, for example, a screen shown in FIG. 6 is displayed on the operation panel 15. Through the screen, the user ID and password are received as inputs.

FIG. 6 is a figure illustrating an example of input screens displayed for entering common input items. In FIG. 6, the input screen 510 shows an input screen for a user ID, and the input screen 520 shows an input screen for a password.

In the present embodiment, in addition to input areas for a user ID and a password, virtual input devices such as a virtual keyboard, or a software keyboard, and the like are displayed. Therefore, the input screens for a user ID and a password are provided separately. Namely, in the input screen 510, when the OK button is pressed after a user ID has been input, the image forming apparatus 10 has the input screen 520 be displayed on the operation panel 15. In the input screen 520, when the OK button is pressed after a password has been input, the image forming apparatus 10 stores the input user ID and password, and moves on to Step S204. It is noted that the image forming apparatus 10 associates the input values from the input screen 510 or the input screen 520 with the corresponding item names to store, for example, in the RAM 112.

It is noted that the user ID input and the password input may be done on a single input screen.

At Step S204, the image forming apparatus 10 determines whether inherent input items exist for the target application to be executed. Whether inherent input items exist may be determined by referring to the value of the “INHERENT ITEM NAME” field in the authentication setup information (FIG. 4) corresponding to the target application to be executed. Namely, if the value, or the item name, is stored in the “INHERENT ITEM NAME” field, it is determined that an inherent input item exists. If the value is not stored in the “INHERENT ITEM NAME” field, it is determined that an inherent input item does not exist.

If the inherent input items exist (“YES” at S204), the image forming apparatus 10 has an input screen for values of inherent input items be displayed on the operation panel 15 at S205.

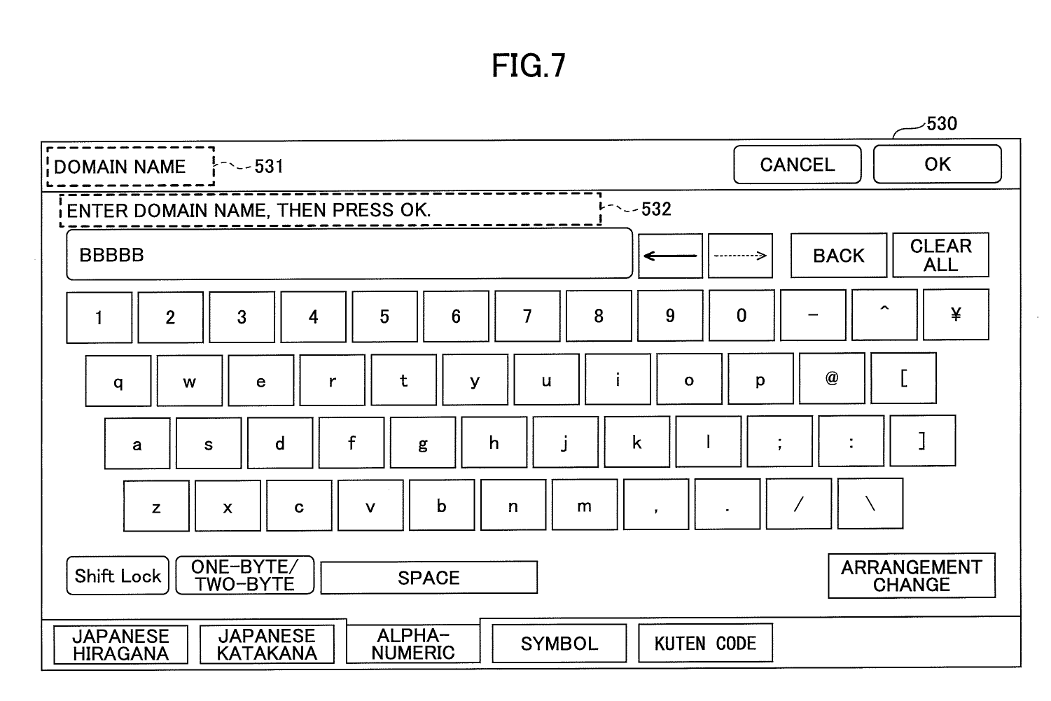

FIG. 7 is a figure illustrating an example of an input screen displayed for entering inherent input items. The input screen 530 in FIG. 7 has a similar configuration of the input screen 510 or 520 shown in FIG. 6.

However, the display area for the input item 531 displays a name of the inherent item in the authentication setup information (FIG. 4) corresponding to the application ID of the target application to be executed. Also, the message display area 532 displays the value of the message in the authentication setup information (FIG. 4) corresponding to the application ID of the target application to be executed.

It is noted that in FIG. 7, the input screen 530 is an example of an input screen displayed when the SDK application 152 with the application ID “ap11” (see FIG. 4) is the target application to be executed.

Next, in the input screen 530, when the OK button is pressed after the value has been input, the image forming apparatus 10 associates the input value with the value of the name of inherent input items to store, for example, to the RAM 112 at Step S206.

On the other hand, if no inherent input item exists (“NO” at Step S204), Steps 5205 and 5206 are not executed to move on to Step S207.

At Step S207, the image forming apparatus 10 indicates the input values of the input items to the target application to be executed. Therefore, when the target application to be executed has the inherent input items, the input values for the inherent input items (a domain name for the example in FIG. 7) is indicated to the target application to be executed, in addition to the user ID and password.

Next, the target application to be executed executes, for example, authentication processing using the indicated values at Step S208. However, it is up to the target application to be executed how to use the indicated values. Specifically, the inherent input items may not be necessarily used for authentication processing, but for other usages or purposes.

Next, operations of the software program in the image forming apparatus 10, which are relevant to the processing steps explained in FIG. 3 and FIG. 5, will be explained.

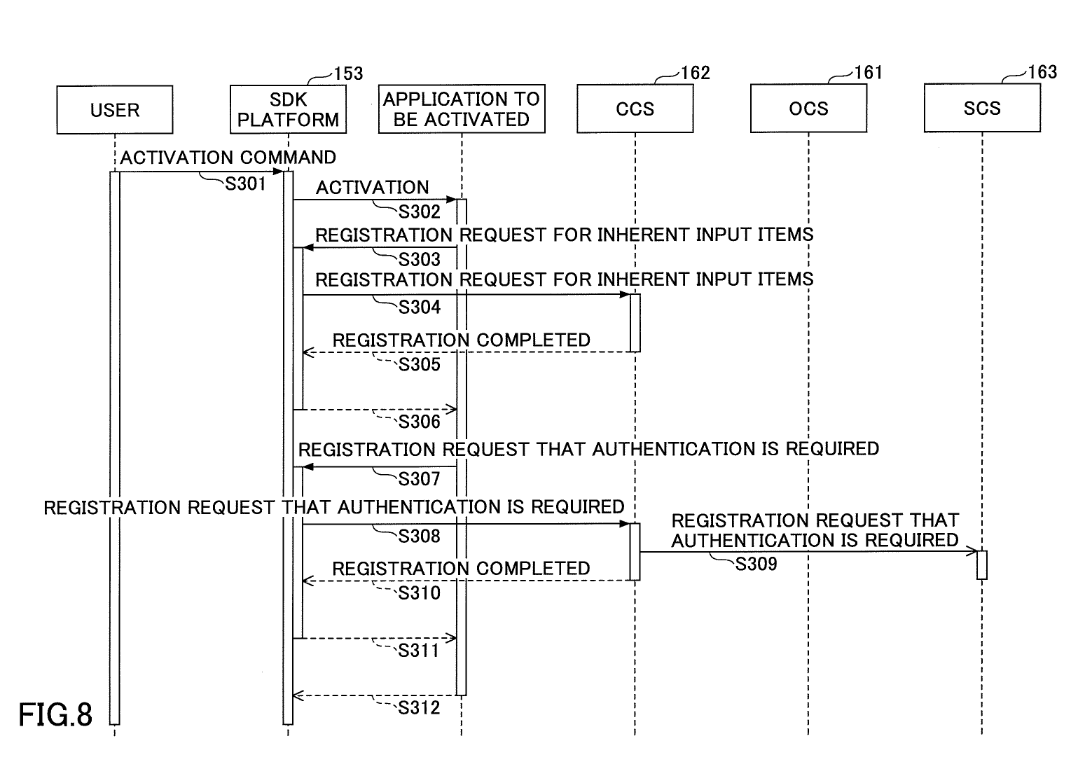

FIG. 8 is a sequence chart illustrating an example of operations of the software programs executed when one of the SDK applications is activated.

At Step S301, the SDK platform 153 receives from a user an activation command of one of the SDK applications 152 installed in the image forming apparatus 10. For example, the SDK platform 153 has the operation panel 15 display a screen for the user to select an SDK application 152 to be activated from a list of the SDK applications 152 installed in the image forming apparatus 10. The SDK platform 153 recognized the application ID of the SDK application 152 selected on the screen, called the “target application to be activated” hereafter, as the identification information of the target application to be activated.

Next, the SDK platform 153 inputs, at Step S302, the activation command to the target application to be activated corresponding to the application ID recognized at Step S301. The application to be activated makes a registration request of attribute information of inherent input items to the SDK platform 153 in the course of the activation processing at Step S303. The request is input to the SDK platform 153, for example, through the API (Application Program Interface) of the SDK platform 153. Specifically, the request is input to the SDK platform 153, by calling a method of the SDK platform 153. The application ID, the name of inherent input items, the message or the like of the target application to be activated are specified as arguments of the method.

However, the attribute information of the inherent input items may be stored in, for example, the NVRAM 115, the HDD 114, etc., as setup information associated with the application ID in advance. In this case, the target application to be activated may not need to make a registration request of the attribute information of the inherent input items to the SDK platform 153. The SDK platform 153 may refer to the setup information, and obtain the attribute information of the inherent input items of the target application to be activated.

Next, the SDK platform 153 makes a registration request of the attribute information to the CCS 162 specifying the application ID of the target application to be activated and the attribute information of the inherent input items specified in the registration request at Step S304. In response to the request, the CCS 162 associates the application ID of the target application to be activated with the indicated attribute information such as the item names, the message, etc., to register as the additional authentication setup information. Next, the CCS 162 returns a reply, for example, to indicate the completion of the registration to the SDK platform 153 at Step S305. The SDK platform 153 returns a response to the request from the target application to be activated at Step 306.

Next, the target application to be activated makes a registration request to the SDK platform 153 that authentication processing is required at Step S307. The request is input to the SDK platform 153, for example, through the API of the SDK platform 153. Specifically, the request is input to the SDK platform 153, by calling a method of the SDK platform 153. The application ID of the target application to be activated is specified as an argument of the method.

However, the necessity of the authentication processing may be stored in, for example, the NVRAM 115, the HDD 114, etc., as setup information associated with the application ID in advance. In this case, the target application to be activated may not need to make a registration request that authentication processing is required to the SDK platform 153. The SDK platform 153 may refer to the setup information, and obtain the necessity of the authentication processing of the target application to be activated.

Next, the SDK platform 153 makes a registration request that authentication processing is required to the CCS 162 specifying the application ID of the target application to be activated at Step 308. Next, the CCS 162 makes a registration request that authentication processing is required to the SCS 163 specifying the application ID of the target application to be activated at Step 309. In response to the request, the SCS 163 records the value “1” in the “NECESSITY OF AUTHENTICATION” field in the authentication setup information. It is noted that the recording to the “NECESSITY OF AUTHENTICATION” may be done by the CCS 162.

Next, the CCS 162 returns a reply to indicate the completion of the registration that authentication processing is required to the SDK platform 153 at Step S310. The SDK platform 153 returns a response to the request from the target application to be activated at Step 311. After the activation process has been completed, the target application to be activated returns a reply to the activation command at Step S302 to the SDK platform 153 at Step S312.

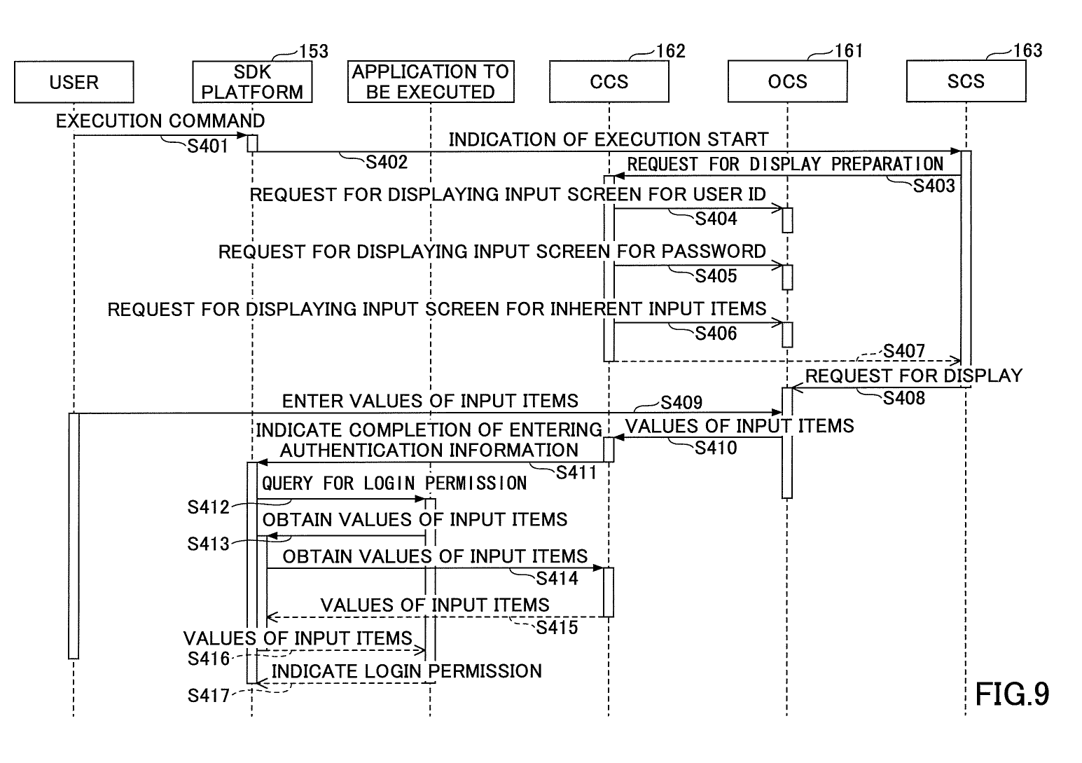

FIG. 9 is a sequence chart illustrating an example of operations of the software programs executed when one of the SDK applications is executed.

At Step S401, the SDK platform 153 receives from a user an execution command of one of the SDK applications 152 installed in the image forming apparatus 10. For example, the SDK platform 153 has the operation panel 15 display a screen for the user to select an SDK application 152 to be executed from a list of the SDK applications 152 installed in the image forming apparatus 10. The SDK platform 153 recognized the application ID of the SDK application 152 selected on the screen, called the “target application to be executed” hereafter, as the identification information of the target application to be activated.

Next, the SDK platform 153 indicates the start of execution of the SDK application 152 associated with the application ID (the target application to be executed) to the SCS 163 with specifying the application ID, at Step S402. The SCS 163 requests to the CCS 162 to execute preparation processing for displaying an input screen for authentication information with specifying the application ID if the “NECESSITY OF AUTHENTICATION” field associated with the application ID has the value “1” in the authentication setup information(FIG. 4), at Step S403.

In response to the request, the CCS 162 requests the OCS 161 to display a screen for common input items. In the present embodiment, a request to display the input screen 510 for a user ID and a request to display the input screen 520 for a password are input to the OCS 161 at Steps S404 and S405.

Next, the CCS 162 inputs to the OCS 161 a request to display an input screen with specifying the inherent items and the message, if the authentication setup information (FIG. 4) includes a value for the “INHERENT ITEM NAME” associated with the application ID, which may be recorded at the execution of preparation processing for displaying the input screen for authentication information, at Step S406. The message is the string recorded in the authentication setup information (FIG. 4) in the “MESSAGE” field associated with the application ID.

It is noted that the OCS 161 generates screen information of an input screen relevant to a display request according to each display request. However, at this stage, the screen requested to be displayed is not displayed. Next, the CCS 162 replies to the SCS 163 that the preparation processing for displaying the input screen for the authentication information has been completed, at Step S407.

In response to the reply, the SCS 163 requests to the OCS 161 to display the input screen for the authentication information, at Step S408. In response to the reply, the OCS 161 has the operation panel 15 display the input screens 510, 520, and 530 based on the screen information generated at Steps S404-S406.

Next, via the input screens 510,520, and 530, values for the input items are input by a user, at Step S409. It is noted that, as explained in FIG. 6 and FIG. 7, in the present embodiment, the input screens 510,520, and 530 are displayed on the operation panel 15 in turn with transitions of the screens induced with progression of inputs to the input items. The OCS 161 indicates the input values to the CCS 162, at Step S410. The CCS 162 associates the input values with the associated item names, and stores them, for example, in the RAM 112. Next, the CCS 162 indicates the completion of the input of the authentication information to the SDK platform 153, at Step S411.

Next, the SDK platform 153 makes a query to the target application to be executed whether a login is allowed or not, i.e., the target application to be executed can be executed or utilized, or not, at Step S412. In response to the query, the target application to be executed requests to the SDK platform 153 to obtain the values of the input items, at Step S413. The SDK platform 153 transfers the request to the CCS 162, at Step S414. In response to the request, the CCS 162 replies to the SDK platform 153 with the associated information of the item names and the input values stored according to Step S410, at Step S415.

Next, the SDK platform 153 indicates the associated information to the target application to be executed, at Step S416. In the present embodiment, the user ID, the password, and the inherent input items are indicated with their values. In response to the indication of the associated information, the target application to be executed executes, for example, authentication processing based on the values of the input items. The execution of the authentication processing based on the values of the common input items may be transferred to a program module such as the CCS 162 and the like, which can be shared by the multiple SDK applications 152. Also, regardless of the inherent input items or the common input items, the execution of the authentication processing based on the values of the input items may be transferred to an outside computer which can be connected to the image forming apparatus 10 via a network.

Also, the values of the inherent input items may not necessarily be used for the authentication process. For example, the values of the inherent input items may be used as parameters to change the contents of functions provided by the target application to be executed.

Next, the SDK application 152 returns a reply to the query whether a login is allowed or not to the SDK platform 153, at Step S417.

As described above, with the present embodiment, as for input items for authentication, it is possible to display and input inherent input items for each of the SDK applications 152. Therefore, the SDK applications 152 can implement various processing controls according to the input values for the inherent input items.

It is noted that in the present embodiment, the example was explained in which the setup for the necessity of authentication and inherent input items are executed at the activation of the SDK application 152. However, the timing for the setup for the necessity of authentication and inherent input items is not limited to the timing at the activation of the SDK application 152. For example, the setup may be executed at installation of the SDK application 152.

Also, the inherent input items may be information other than the domain name used in the above example. For example, address information such as an IP address, a telephone number, a mail address, or a FAX number or the like may be specified as inherent input items. In this case, for example, the address information input to the inherent input items may be used as identification information to which the SDK application 152 may access or send information. Also, the inherent input items may be attribute information of a user such as a department name or an identification number of a user, or an official title of a user and the like. In this case, according to the attribute information input as the inherent input items, the processing control of the SDK application 152 may change.

Also, the authentication setup information (FIG. 4) may be stored in places other than inside of the image forming apparatus 10. For example, the authentication setup information may be stored in an outside computer which can be connected to the image forming apparatus 10 via a network.

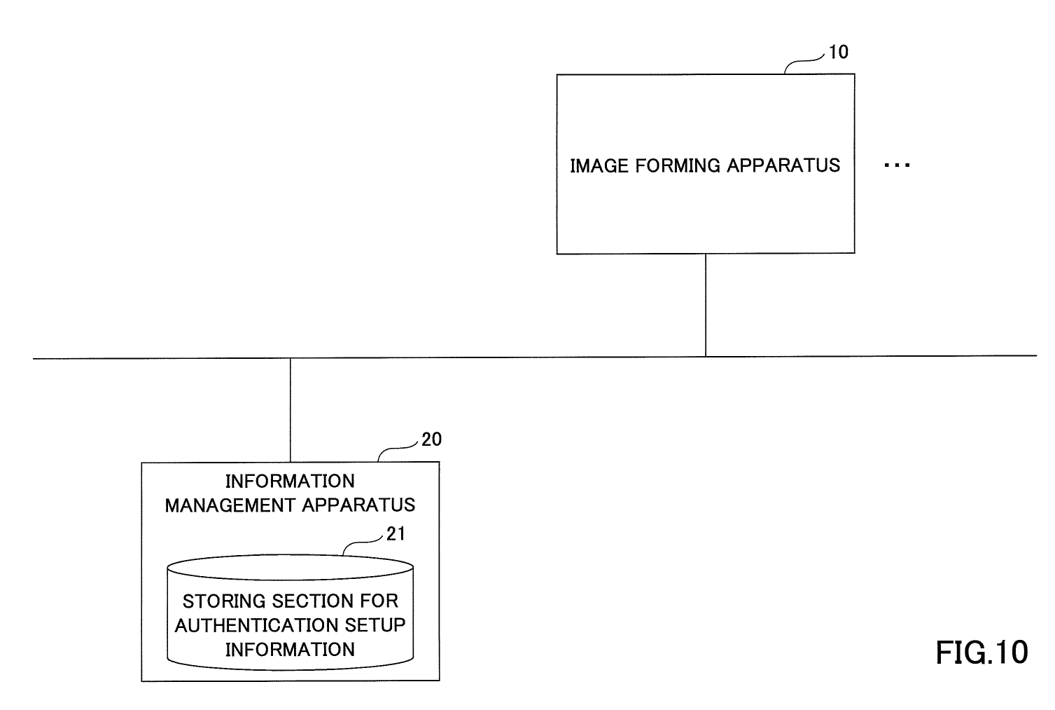

FIG. 10 is a figure illustrating an example of a system configuration where the authentication setup information is stored outside of the image forming apparatus.

In FIG. 10, the information management apparatus 20 is connected to one or more image forming apparatuses 10 via a network such as a LAN (Local Area Network) or the Internet. The information management apparatus 20 includes a storing section for authentication setup information 21. The storing section for authentication setup information 21 stores the authentication setup information of each of the SDK applications 152. The storing section for authentication setup information 21 may be implemented, for example, with a non-volatile storing medium which may be included in the information management apparatus 20.

When the system configuration shown in FIG. 10 is adopted, for example, the SDK platform 153 sends attribute information of inherent input items to the information management apparatus 20 at Step S304 in FIG. 8. The information management apparatus 20 stores the attribute information in the storing section for authentication setup information 21. Also, the SDK platform 153 sends notice, at Step S308, that authentication processing is required, to the information management apparatus 20. The information management apparatus 20 stores the notice that authentication processing is required, into the storing section for authentication setup information 21.

Also, for example, the CCS 162 executes Step S406 and the like in FIG. 9 using the authentication setup information stored in the storing section for authentication setup information 21.

Also, electronic devices to which the present embodiment is applied may not be limited to the image forming apparatus 10. The present embodiment may be applicable to, for example, a projector, a smart phone, a cellphone, a digital camera, and other electronic devices provided that input items can be displayed when authentication.

It is noted that in the present embodiment, the SDK platform 153 is an example of the reception section and the indicating section. The RAM 112, the HDD114, and the NVRAM 115 are examples of the storing section. The OCS 161 is an example of the display controlling section.

As above, the embodiment was described in detail. Further, the present invention is not limited to these embodiments, but various variations and modifications may be made without departing from the scope of the present invention.

The present application is based on Japanese Priority Application No. 2012-007778 filed on Jan. 18, 2012, and Japanese Priority Application No. 2012-236411 filed on Oct. 26, 2012, with the Japanese Patent Office, the entire contents of which are hereby incorporated by reference.

1. An electronic device comprising:
a reception section to receive, from an installed program, attribute information of input items inherent to the installed program as input items for authentication;
a storing section to store the attribute information;
a display controlling section to display an input screen on a display section for entering the input items inherent to the program in addition to common input items for multiple programs based on the attribute information stored in the storing section, in response to an execution command to execute the program; and
an indicating section to indicate input values for the input items inherent to the program to the program requiring the inherent input items.

2. The electronic device as claimed in claim 1,
wherein the reception section receives, from the program, information indicating necessity of authentication,
the storing section stores the information indicating the necessity of authentication, and
the display controlling section displays the input screen with respect to the program requiring authentication according to the information stored in the storing section.

3. The electronic device as claimed in claim 1,
wherein the storing section stores the attribute information for multiple programs such that the attribute information is associated with the identification information of multiple programs,
the display controlling section causes the display section to display the input screen for entering the inherent input items based on the attribute information corresponding to the identification information of the program in the storing section, with respect to the execution command to execute the program.

4. The electronic device as claimed in claim 1,
wherein the attribute information includes item names of the inherent input items and strings prompting inputting of the inherent input items.

5. An information processing system comprising:
an electronic device; and
an information management apparatus connected to the electronic device via a network,
wherein the electronic device comprises:
a reception section to receive, from an installed program, attribute information of input items inherent to the installed program as input items for authentication;
a display controlling section to display an input screen on a display section for entering the input items inherent to the program in addition to common input items for multiple programs based on the attribute information, in response to an execution command to execute the program; and
an indicating section to indicate input values for the input items inherent to the program to the program with respect to the inherent input items,
the information management apparatus comprises:
a storing section to store the attribute information received by the reception section.

6. An information management apparatus connected via a network to the electronic device as claimed in claim 1, wherein the information management apparatus comprises:
a storing section to store the attribute information received by the reception section.

7. An information processing method executed by an electronic device, comprising the steps of:
(a) receiving, from an installed program, attribute information of input items inherent to the installed program as input items for authentication;
(b) storing the attribute information;
(c) displaying an input screen on a display section for entering the input items inherent to the program in addition to common input items for multiple programs based on the attribute information stored in the storing section, in response to an execution command to execute the program; and
(d) indicating input values for the input items inherent to the program to the program with respect to the inherent input items.

8. The method as claimed in claim 7,
wherein step (a) further receives from the program, information indicating necessity of authentication,
step (b) further stores the information indicating the necessity of authentication, and
step (c) further displays the input screen with respect to the program requiring authentication according to the information stored in the storing section.

9. The method as claimed in claim 7,
wherein step (b) further stores the attribute information for multiple programs such that the attribute information is associated with the identification information of multiple programs,
step (c) further causes the display section to display the input screen for entering the inherent input items based on the attribute information corresponding to the identification information of the program in the storing section, with respect to the execution command to execute the program.

10. The method as claimed in claim 7,
wherein the attribute information includes item names of the inherent input items and strings prompting inputting of the inherent input items.
